(19) United States
(12) Patent Application Publication
(10) Pub. No.: US 2019/0346566 A1
(43) Pub. Date: Nov. 14, 2019

(54) SURFACE DETECTION METHOD

(71) Applicants: CHIH-CHIEH LIN, NEW TAIPEI CITY (TW); HSIEN-KUO WANG, NEW TAIPEI CITY (TW); GAUSS DESIGN INC, New Taipei City (TW)

(72) Inventors: CHIH-CHIEH LIN, NEW TAIPEI CITY (TW); HSIEN-KUO WANG, NEW TAIPEI CITY (TW)

(21) Appl. No.: 15/977,468

(22) Filed: May 11, 2018

(51) Int. Cl. G01S 15/89; G01N 29/06

(52) U.S. Cl. CPC G01S 15/8997; G06T 2207/10132; G01N 29/069

(57) ABSTRACT

A surface detection method of the present disclosure firstly establishes at least one ultrasonic image model and at least one optical image model, and then respectively compares a tested ultrasonic image and a tested optical image of a test object to obtain two comparison results after acquiring the tested ultrasonic image and the tested optical image of the test object, so as to achieve an objective of surface detection. The present disclosure not only can obtain an accurate detection result, but also reduce the much detection time, therefore being suitable for the application of the automatically continuous processing process. Accordingly, the present disclosure provides a relatively positive and reliable means for preventing from the continuous production of fault products, and for monitoring the availability of the production processing line device.

### BACKGROUND

### 1. Technical Field

The present disclosure relates to a detection technology, in particular, to a surface detection method, wherein the surface detection method can reduce the detection time and be suitable for the requirement of the application of the automatically continuous processing process.

### 2. Description of Related Art

In the current processing and manufacturing field, the surface quality detection of the product is very important. In addition to check the processing completeness of the product to maintain the processing quality of the product, the surface detection can further find whether the related processing device operates abnormally or runs down according to the produced defect on the product surface.

The conventional surface detection method for the product is usually performed by a visual inspection manner. Generally, after the quality checker visually checks the surface statuses of the upper surface and the lower surface associated with the produce, she or he must make a related detection judgment in time, and the detection results may differ from person to person, thus not being able to reflect the whole quality statuses of the products in time due to the occasional detection loss.

As the technology advances, the digital image recognition ability is enhanced. The related automatic surface detection system is provided accordingly, and the well-known scanning manner by using the optical instrument (such as, infrared ray scanner) is used to check the defect on the product surface. Since the optical scanning forms the line from the points, and forms the surface from the lines, it must cost long time, and the time interval for randomly sampling is relatively increased. Therefore, such prior art is not suitable for the current requirement of the application of the automatically continuous processing process.

### SUMMARY

Accordingly, the present disclosure is used to provide a surface detection method being used to reduce the detection time and suitable for the requirement of the application of the automatically continuous processing process.

The present disclosure provides a surface detection method, at least comprising steps of: (a) establishing at least one ultrasonic image model and at least one optical image model; (b) setting a range and a tested value of a tested item, and using a software, according to the tested item, to set at least one ultrasonic image detection range and at least one ultrasonic tested value of the at least one ultrasonic image model, and to set at least one optical image detection range and at least one optical tested value of the at least one the optical image model, wherein the at least one ultrasonic image detection range, the at least one ultrasonic tested value, the at least one optical image detection range and the at least one optical tested value correspond to the tested item; (c) providing a tested object; (d) acquiring a tested ultrasonic image and a tested optical image of the tested object, wherein the tested ultrasonic image of the tested object is acquired by at least one ultrasonic imaging device, and the tested optical image of the tested object is acquired by at least one optical imaging device; (e) comparing the tested ultrasonic image the tested optical image respectively, wherein according to the ultrasonic image detection range and the ultrasonic tested value set by the software, digital image information of the tested ultrasonic image is compared to digital image information of the at least one ultrasonic image model, and according to the optical image detection range and the optical tested value set by the software, digital image information of the tested optical image is compared to digital image information of the at least one optical image model; (f) outputting comparison results.

Accordingly, the surface detection method of the present disclosure respectively compares a tested ultrasonic image and a tested optical image of a test object to obtain two comparison results, so as to achieve an objective of surface detection. It not only can obtain an accurate detection result, but also reduce the much detection time, therefore being suitable for the application of the automatically continuous processing process.

According to the above technical features, the at least one ultrasonic image model or the at least one optical image model is established by the software, and the ultrasonic image model and the optical image model correspond to the tested object.

According to the above technical features, after completing a physical model corresponding the tested object and acquiring an ultrasonic image of the physical model by using the at least one ultrasonic imaging device, the surface detection method completes establishment of the at least one ultrasonic image model.

According to the above technical features, after completing a physical model corresponding the tested object and acquiring an optical image of the physical model by using the at least one optical imaging device, the surface detection method completes establishment of the at least one optical image model.

According to the above technical features, after completing a physical model corresponding the tested object and acquiring an ultrasonic image of the physical model by using the at least one ultrasonic imaging device, the surface detection method utilizes the software to modify the ultrasonic image of the physical model, so as to complete establishment of the at least one ultrasonic image model.

According to the above technical features, after completing a physical model corresponding the tested object and acquiring an optical image of the physical model by using the at least one optical imaging device, the surface detection method utilizes the software to modify the optical image of the physical model, so as to complete establishment of the at least one optical image model.

When comparing the tested ultrasonic image and the tested optical image respectively, the surface detection method further performs a cross comparison by a manner for overlapping at least one ultrasonic image model and tested optical image, and for overlapping the at least one optical image model and the tested ultrasonic image.

The tested object is a product or semi-finished product stopped on a production processing line.

The tested object is a product or semi-finished product moving on a production processing line.

The tested object is a product or semi-finished product removed from a production processing line.

The surface detection method further transmits, via at least one transmission interface, the comparison results of the tested ultrasonic image and the tested optical image to at least one display device, wherein the at least one display device is connected to the at least one transmission interface.

The surface detection method further transmits, via at least one transmission interface, the comparison results of the tested ultrasonic image and the tested optical image to at least one control device, wherein the at least one control device is connected to the at least one transmission interface.

The surface detection method further transmits, via at least one transmission interface, the comparison results of the tested ultrasonic image and the tested optical image to at least one display device and at least one control device, wherein the at least one display device and the at least one control device are connected to the at least one transmission interface.

To sum up, the surface detection method of the present disclosure respectively compares a tested ultrasonic image and a tested optical image of a test object to obtain two comparison results, so as to achieve an objective of surface detection. It not only can obtain an accurate detection result, but also reduce the much detection time, therefore being suitable for the application of the automatically continuous processing process. Accordingly, a relatively positive and reliable means is provided for preventing from the continuous production of fault products, and for monitoring the availability of the production processing line device.

### BRIEF DESCRIPTION OF THE DRAWINGS

FIG. 1 is a basic flow chart of the present disclosure.

FIG. 2 is a schematic diagram showing one embodiment for acquiring a tested ultrasonic image and a tested optical image of the present disclosure.

FIG. 3 is a schematic diagram showing a status comparison of a tested ultrasonic image and an ultrasonic image model of the present disclosure.

### DESCRIPTION OF THE EXEMPLARY EMBODIMENTS

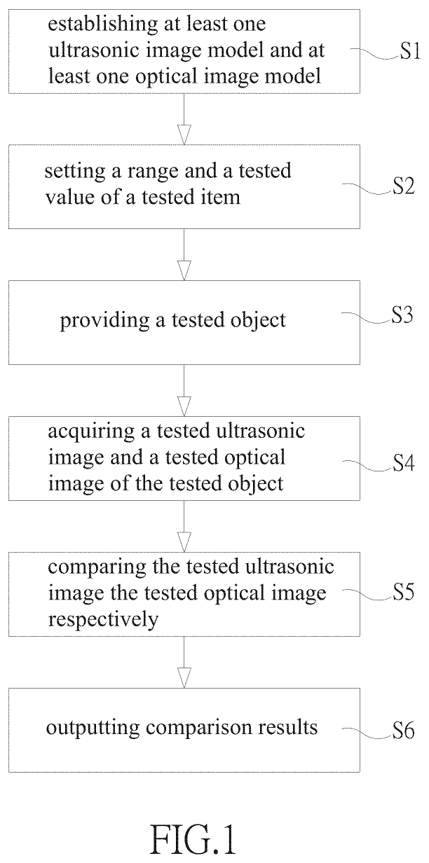

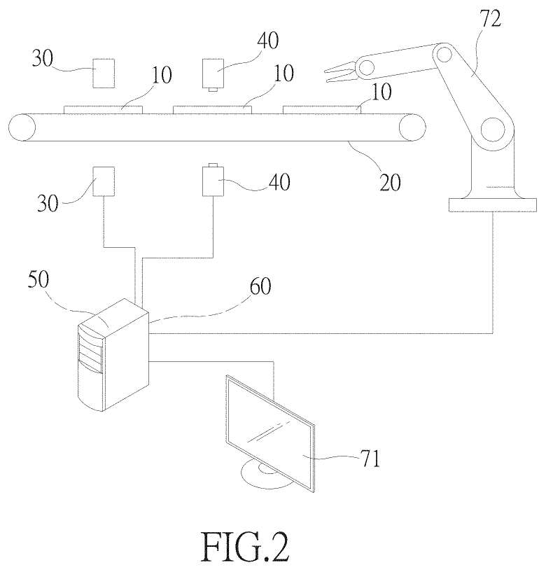

The present disclosure is used to provide a surface detection method being used to reduce the detection time and suitable for the requirement of the application of the automatically continuous processing process. Referring to FIG. 1 and FIG. 2 simultaneously, the surface detection method of the present disclosure at least comprises the following steps.

(a) Step S1 is used for establishing at least one ultrasonic image model and at least one optical image model. Principally, the at least one ultrasonic image model or the at least one optical image model can be established by a software, wherein the ultrasonic image model and the optical image model correspond to the tested object.

(b) Step S2 is used for setting a range and a tested value of a tested item, and using a software, according to the tested item, to set at least one ultrasonic image detection range and at least one ultrasonic tested value of the at least one ultrasonic image model, and to set at least one optical image detection range and at least one optical tested value of the at least one the optical image model, wherein the at least one ultrasonic image detection range, the at least one ultrasonic tested value, the at least one optical image detection range and the at least one optical tested value correspond to the tested item.

(c) Step S3 is used for providing a tested object 10. When the present disclosure is implemented, the tested object 10 can be a product or semi-finished product stopped on a production processing line, or the tested object 10 can be a product or semi-finished product moving on a production processing line as shown in FIG. 2. Certainly, tested object 10 can further be a product or semi-finished product removed from a production processing line.

(d) Step S4 is used for acquiring a tested ultrasonic image and a tested optical image of the tested object 10. As shown in FIG. 2, the tested ultrasonic image of the tested object 10 is acquired by at least one ultrasonic imaging device 30, and the tested optical image of the tested object 10 is acquired by at least one optical imaging device, such as the digital camera 40.

(e) Step S5 is used for comparing the tested ultrasonic image the tested optical image respectively. According to the ultrasonic image detection range and the ultrasonic tested value set by the software 50, digital image information of the tested ultrasonic image is compared to digital image information of the at least one ultrasonic image model, and according to the optical image detection range and the optical tested value set by the software 50, digital image information of the tested optical image is compared to digital image information of the at least one optical image model

(f) Step S6 is used for outputting comparison results. The surface detection method further transmits, via at least one transmission interface 60, the comparison results of the tested ultrasonic image and the tested optical image to at least one device, wherein the at least one device is connected to the at least one transmission interface 60. When the present disclosure is implemented, the at least one transmission interface 60 is connected to at least one display device 71 or at least one control device 72. As shown in FIG. 2, the at least one transmission interface 60 is connected to both of the at least one display device 71 and the at least one control device 72. In addition to utilize the display device 71 to show the comparison results in time, the control device 72 can be further utilized to deal with the defected tested object 10 according to the comparison results, such as removing the defected tested object 10 from the production processing line or weeding the defected tested object 10 out the production processing line.

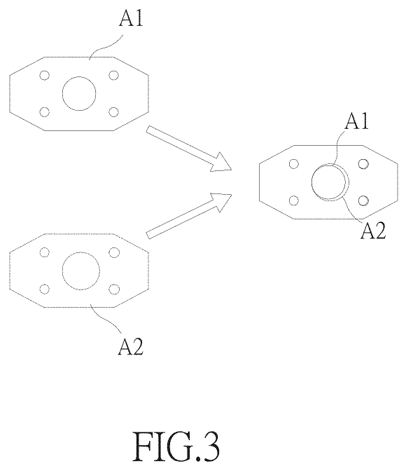

When comparing the tested ultrasonic image, as shown in FIG. 3, by using the software, the surface detection method of the present disclosure can overlap the at least one ultrasonic image model A1 (presented by the solid line in FIG. 3) and the tested ultrasonic image A2 (presented by the dot line in FIG. 3), and then find the difference(s) between the at least one ultrasonic image model A1 and the tested ultrasonic image A2 accordingly. By the similar manner, when comparing the tested optical image, by using the software, the surface detection method of the present disclosure can overlap the at least one optical image model and the tested optical image, and then find the difference(s) between the at least one optical image model and the tested optical image accordingly. Of course, when comparing the tested ultrasonic image and the tested optical image respectively, the surface detection method further performs a cross comparison by a manner for overlapping at least one ultrasonic image model and tested optical image, and for overlapping the at least one optical image model and the tested ultrasonic image.

Accordingly, the surface detection method respectively compares a tested ultrasonic image and a tested optical image of a test object to obtain two comparison results, so as to achieve an objective of surface detection. The present disclosure can reduce much detection time, further shorten the time interval for randomly sampling, and detect the products or the semi-finished product in sequence. The present disclosure is suitable for the application of the automatically continuous processing process, such as the plate stamping or unmanned factory. Therefore, the present disclosure provides a relatively positive and reliable means for preventing from the continuous production of fault products, and for monitoring the availability of the production processing line device.

Furthermore, when the present disclosure is implemented, after completing a physical model corresponding the tested object and acquiring an ultrasonic image of the physical model by using the at least one ultrasonic imaging device, the surface detection method of the present disclosure completes establishment of the at least one ultrasonic image model; and after completing a physical model corresponding the tested object and acquiring an optical image of the physical model by using the at least one optical imaging device, the surface detection method of the present disclosure completes establishment of the at least one optical image model.

Furthermore, in another embodiment, after completing a physical model corresponding the tested object and acquiring an ultrasonic image of the physical model by using the at least one ultrasonic imaging device, the surface detection method of the present disclosure utilizes the software to modify the ultrasonic image of the physical model, so as to complete establishment of the at least one ultrasonic image model; and after completing a physical model corresponding the tested object and acquiring an optical image of the physical model by using the at least one optical imaging device, the surface detection method of the present disclosure utilizes the software to modify the optical image of the physical model, so as to complete establishment of the at least one optical image model.

It is noted that, after the surface detection method of the present disclosure completes the comparisons of the tested ultrasonic image and the tested optical image, a database can be established to record all comparison results, and to name the defect features of the comparison results, so as to facilitate the establishment of efficient defect detection rule.

Specifically, the surface detection method of the present disclosure respectively compares a tested ultrasonic image and a tested optical image of a test object to obtain two comparison results, so as to achieve an objective of surface detection. It not only can obtain an accurate detection result, but also reduce the much detection time, therefore being suitable for the application of the automatically continuous processing process. Accordingly, a relatively positive and reliable means is provided for preventing from the continuous production of fault products, and for monitoring the availability of the production processing line device.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A surface detection method, at least comprising steps of:
(a) establishing at least one ultrasonic image model and at least one optical image model;
(b) setting a range and a tested value of a tested item, and using a software, according to the tested item, to set at least one ultrasonic image detection range and at least one ultrasonic tested value of the at least one ultrasonic image model, and to set at least one optical image detection range and at least one optical tested value of the at least one the optical image model, wherein the at least one ultrasonic image detection range, the at least one ultrasonic tested value, the at least one optical image detection range and the at least one optical tested value correspond to the tested item;
(c) providing a tested object;
(d) acquiring a tested ultrasonic image and a tested optical image of the tested object, wherein the tested ultrasonic image of the tested object is acquired by at least one ultrasonic imaging device, and the tested optical image of the tested object is acquired by at least one optical imaging device;
(e) comparing the tested ultrasonic image the tested optical image respectively, wherein according to the ultrasonic image detection range and the ultrasonic tested value set by the software, digital image information of the tested ultrasonic image is compared to digital image information of the at least one ultrasonic image model, and according to the optical image detection range and the optical tested value set by the software, digital image information of the tested optical image is compared to digital image information of the at least one optical image model; and
(f) outputting comparison results.

2. The surface detection method according to claim 1, wherein the at least one ultrasonic image model or the at least one optical image model is established by the software, and the ultrasonic image model and the optical image model correspond to the tested object.

3. The surface detection method according to claim 1, wherein after completing a physical model corresponding the tested object and acquiring an ultrasonic image of the physical model by using the at least one ultrasonic imaging device, the surface detection method completes establishment of the at least one ultrasonic image model.

4. The surface detection method according to claim 1, wherein after completing a physical model corresponding the tested object and acquiring an optical image of the physical model by using the at least one optical imaging device, the surface detection method completes establishment of the at least one optical image model.

5. The surface detection method according to claim 1, wherein after completing a physical model corresponding the tested object and acquiring an ultrasonic image of the physical model by using the at least one ultrasonic imaging device, the surface detection method utilizes the software to modify the ultrasonic image of the physical model, so as to complete establishment of the at least one ultrasonic image model.

6. The surface detection method according to claim 1, wherein after completing a physical model corresponding the tested object and acquiring an optical image of the physical model by using the at least one optical imaging device, the surface detection method utilizes the software to modify the optical image of the physical model, so as to complete establishment of the at least one optical image model.

7. The surface detection method according to claim 1, wherein when comparing the tested ultrasonic image and the tested optical image respectively, the surface detection method further performs a cross comparison by a manner for overlapping at least one ultrasonic image model and tested optical image, and for overlapping the at least one optical image model and the tested ultrasonic image.

8. The surface detection method according to claim 1, wherein the tested object is a product or semi-finished product stopped on a production processing line.

9. The surface detection method according to claim 1, wherein the tested object is a product or semi-finished product moving on a production processing line.

10. The surface detection method according to claim 1, the tested object is a product or semi-finished product removed from a production processing line.

11. The surface detection method according to claim 1, wherein the surface detection method further transmits, via at least one transmission interface, the comparison results of the tested ultrasonic image and the tested optical image to at least one display device, wherein the at least one display device is connected to the at least one transmission interface.

12. The surface detection method according to claim 1, wherein the surface detection method further transmits, via at least one transmission interface, the comparison results of the tested ultrasonic image and the tested optical image to at least one control device, wherein the at least one control device is connected to the at least one transmission interface.

13. The surface detection method according to claim 1, wherein the surface detection method further transmits, via at least one transmission interface, the comparison results of the tested ultrasonic image and the tested optical image to at least one display device and at least one control device, wherein the at least one display device and the at least one control device are connected to the at least one transmission interface.
